(19) United States
(12) Patent Application Publication
(10) Pub. No.: US 2018/0262438 A1
(43) Pub. Date: Sep. 13, 2018

(54) COMMUNICATION METHOD AND ZONE SCHEDULER AND INTER-ZONE SCHEDULING COORDINATOR (IZSC)

(71) Applicant: Electronics and Telecommunications Research Institute, Daejeon (KR)

(72) Inventors: Jongtae SONG, Daejeon (KR); Daeub KIM, Daejeon (KR); Kyeong-Eun HAN, Daejeon (KR); Sun Me KIM, Daejeon (KR); Chansung PARK, Sejong-si (KR); Ji Wook YOUN, Daejeon (KR)

(73) Assignee: Electronics and Telecommunications Research Institute, Daejeon (KR)

(21) Appl. No.: 15/724,398

(22) Filed: Oct. 4, 2017

(30) Foreign Application Priority Data
Mar. 10, 2017 (KR) 10-2017-0030815

(51) Int. Cl. H04L 12/863; H04L 12/911; H04L 12/803; H04L 12/815

(52) U.S. Cl. CPC H04L 47/6295; H04L 47/726; H04L 49/206; H04L 47/22; H04L 47/125

(57) ABSTRACT

Disclosed is a communication method, a zone scheduler performing thereof, and an inter-zone scheduling coordinator (IZSC). A communication method performed by a zone scheduler may include transmitting an inter-zone scheduling request to an IZSC in response to an occurrence of an inter-zone traffic with respect to another zone scheduler, receiving an inter-zone matching pattern and information on a time slot from the IZSC, and transmitting the inter-zone traffic to the other zone scheduler by performing scheduling based on the inter-zone matching pattern in the time slot.

### CROSS-REFERENCE TO RELATED APPLICATION(S)

This application claims the priority benefit of Korean Patent Application No. 10-2017-0030815 filed on Mar. 10, 2017, in the Korean Intellectual Property Office, the disclosure of which is incorporated herein by reference for all purposes.

### BACKGROUND

### 1. Field

One or more example embodiments relate to a communication method, a zone scheduler, and an inter-zone scheduling coordinator (IZSC) performing thereof, and more particularly, to a technology for implementing a mono-hierarchical network by controlling a scheduling operation of a plurality of zone schedulers based on an inter-zone matching pattern determined by the IZSC.

### 2. Description of Related Art

A data center may be classified as a small data center, a medium data center, and a large data center based on a number of server racks. One server rack includes 16 internal servers, and a server rack may be connected to a network through a top of rack (ToR) switch. The ToR switch may connect internal servers included in an identical server rack. The internal server racks may be connected to servers included in other server racks through an aggregation switch. When a number of server racks is increased in response to the data center being expanded, a network may be extended by adding a second aggregation switch. When a number of server racks is increased even more, a third aggregation switch and a fourth aggregation switch may be added.

As the data center network becomes more hierarchical, a quality of the network may deteriorate.

### SUMMARY

One or more example embodiments may provide a mono-hierarchical network to minimize a delay between terminations and prevent a quality degradation occurring in a hierarchical network.

One or more example embodiments may control starvation and prevent a duplicated grant problem that grants simultaneously occur from one input to a plurality of output ports by controlling a scheduling operation of a plurality of zone schedulers based on an inter-zone matching pattern determined by an inter-zone scheduling coordinator (IZSC). In addition, one or more example embodiments may effectively solve a scalability problem occurring in response to an input arbiter (IA) corresponding to all inputs while an output arbiter (OA) corresponds to each zone.

One or more example embodiments may guarantee a high performance with respect to a traffic occurring between identical zones in addition to a high performance of a traffic occurring between different zones when the present disclosure is applied to a network of a zone-based data center.

According to an aspect, there is provided a communication method performed by a zone scheduler including transmitting an inter-zone scheduling request to an inter-zone scheduling coordinator (IZSC) in response to an occurrence of an inter-zone traffic with respect to another zone scheduler, receiving an inter-zone matching pattern and information on a time slot from the IZSC, and transmitting the inter-zone traffic to the other zone scheduler by performing scheduling based on the inter-zone matching pattern in the time slot.

The communication method may further include performing scheduling for an intra-zone traffic in a time slot differing from the time slot, wherein the intra-zone traffic occurs between a plurality of servers included in a zone corresponding to the zone scheduler.

The inter-zone scheduling request may include information on a source zone that requests inter-zone scheduling, a destination zone to which the inter-zone scheduling is to be performed, and a number of non-empty virtual output queues (VoQs) for each destination zone.

The receiving of the inter-zone matching pattern and the information on the time slot may include receiving information on a source zone that requests inter-zone scheduling, a destination zone capable of performing scheduling with the source zone, and a time slot for performing the inter-zone scheduling.

The inter-zone matching pattern may match at least two zone schedulers that require the scheduling most among a plurality of zone schedulers of which the scheduling is controlled by the IZSC.

The inter-zone matching pattern may control the scheduling of the zone schedulers based on an inter-zone traffic of the zone schedulers.

The zone scheduler may control an intra-zone traffic between a plurality servers classified as an identical zone based on a type.

According to another aspect, there is provided a communication method performed by an inter-zone scheduling coordinator (IZSC) including receiving an inter-zone scheduling request with respect to a second zone scheduler from a first zone scheduler in which an inter-zone traffic occurs, determining an inter-zone matching pattern based on the inter-zone scheduling request and information on a time slot in which scheduling is to be performed based on the inter-zone matching pattern, and transmitting the inter-zone matching pattern and the information on the time slot to the first zone scheduler and the second zone scheduler.

The determining of the inter-zone matching pattern and the information on the time slot may include determining information on a source zone that requests inter-zone scheduling, a destination zone capable of performing scheduling with the source zone, and a time slot in which the inter-zone scheduling is to be performed.

The inter-zone matching pattern may match a first zone scheduler and the second zone scheduler that require the scheduling most among a plurality of zone schedulers of which the scheduling is controlled by the IZSC.

A greatest amount of inter-zone traffic may occur between the first zone scheduler and the second zone scheduler, among the zone schedulers.

The inter-zone matching pattern may control scheduling of at least three zone schedulers based on the inter-zone traffic of a plurality of zone schedulers of which the scheduling is controlled by the IZSC, and may be determined to perform the scheduling for the inter-zone traffic from the first zone scheduler to the second zone scheduler.

Each of the first zone scheduler and the second zone scheduler may perform scheduling based on the inter-zone matching pattern in the time slot and perform scheduling for an intra-zone traffic between a plurality of servers classified as an identical zone based on a type in a time slot differing from the time slot.

The inter-zone scheduling request may include information on a source zone that requests inter-zone scheduling, a destination zone to which the inter-zone scheduling is to be performed, and a number of non-empty virtual output queues (VoQs) for each destination zone.

The determining of the inter-zone matching pattern and the information on the time slot may include determining the inter-zone matching pattern for matching at least two zone schedulers among a plurality of zone schedulers such that a greatest amount of inter-zone traffic occurring from the zone schedulers connected to the IZSC is processed, and an input arbiter (IA) and an output arbiter (OA) of each of the zone schedulers independently and sequentially operate.

The determining of the inter-zone matching pattern and the information on the time slot may include selecting, as the inter-zone matching pattern, a basic matching pattern for matching two schedulers that require the scheduling most from among basic matching patterns for matching two zone schedulers among a plurality of zone schedulers connected to the IZSC.

According to still another aspect, there is provided a zone scheduler including a processor, and a memory including at least one instruction to be executable by the processor, wherein, in response to the at least one instruction being executed by the processor, the processor is configured to transmit an inter-zone scheduling request to an inter-zone scheduling coordinator (IZSC) in response to an occurrence of an inter-zone traffic with respect to another zone scheduler, receive an inter-zone matching pattern and information on a time slot from the IZSC, and transmit the inter-zone traffic to the other zone scheduler by performing scheduling based on the inter-zone matching pattern in the time slot.

The zone scheduler may further include a scheduling core configured to perform scheduling using a zone corresponding to the zone scheduler as an output port, and a virtual output queue (VoQ) state cache configured to store a VoQ state using the zone corresponding to the zone scheduler as the output port in input ports of all zones connected to the IZSC.

The scheduling core may perform the scheduling based on the inter-zone matching pattern by changing a state of a predetermined source zone to a VoQ state based on the inter-zone matching pattern.

The processor may be configured to perform scheduling for an intra-zone traffic in a time slot differing from the time slot, and the intra-zone traffic may occur between a plurality of servers included in a zone corresponding to the zone scheduler.

The inter-zone matching pattern may match two zone schedulers that require the scheduling most among a plurality of zone schedulers of which the scheduling is controlled by the IZSC.

The inter-zone matching pattern may control scheduling of at least three zone schedulers based on the inter-zone traffic of a plurality of zone schedulers of which scheduling is controlled by the IZSC.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a network system according to an example embodiment;

FIG. 2 is a block diagram illustrating an inter-zone scheduling coordinator (IZSC) and a plurality of zone schedulers according to an example embodiment;

FIGS. 3 through 5 are diagrams each illustrating a connection relationship between an inter-zone scheduling coordinator (IZSC) and a plurality of zone schedulers according to an example embodiment;

FIG. 6 is a diagram illustrating a zone scheduler according to an example embodiment;

FIG. 7 is a diagram illustrating a communication method according to an example embodiment;

FIGS. 8 through 10 are diagrams illustrating a complete matching algorithm according to an example embodiment;

FIG. 11 is a diagram illustrating an inter-zone matching pattern based on a single-pair matching algorithm according to an example embodiment;

FIG. 12 is a diagram illustrating a single-pair matching algorithm according to an example embodiment; and

FIG. 13 is a block diagram illustrating an electronic device according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between“, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The example embodiments may be employed for a communication. Hereinafter, an operation for the communication may include an operation of performing scheduling for traffic. Hereinafter, the example embodiments will be described. Like reference numerals refer to like elements throughout.

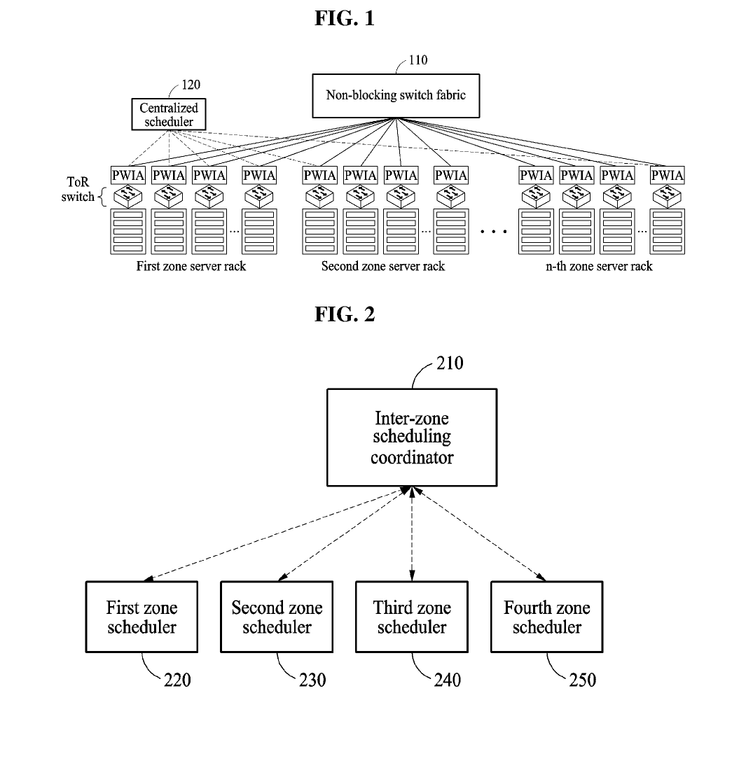

FIG. 1 is a diagram illustrating a network system according to an example embodiment.

FIG. 1 illustrates a network in which a plurality of server rack are connected through Single hop.

When a network of a data center is provided as an optical network, a non-blocking switch fabric 110 is provided in a passive photonic element such that a switch data plane is provided. A photonic wrapper IC assembly (PWIA) may convert an electric signal, for example, a packet and a frame, into an optical signal, for example, an optical frame. The optical signal converted by the PWIA may be switched to a destination PWIA.

Thus, a scalability of a centralized scheduler 120 should be provided. The destination PWIA needs to be controlled by the centralized scheduler 120 to prevent a collision from occurring in the destination PWIA. A pattern of the non-blocking switch fabric 110 may be matched through a centralized control.

FIG. 2 is a block diagram illustrating an inter-zone scheduling coordinator (IZSC) and a plurality of zone schedulers according to an example embodiment.

FIG. 2 illustrates a relationship between an IZSC 210 and a plurality of zone schedulers 220, 230, 240, and 250.

To enhance an efficiency in management of traffic, servers in a data center may be classified as any one zone among a plurality of zones based on a type of each of the servers. The identical type of servers may be managed and classified as an identical zone. Here, a type of server may be determined based on a characteristic of the server or a type of an institution that manages the server. For example, the institution that manages the server includes a private enterprise, a public institution, and a school, and the characteristic of the server includes a video server, a document server, a working system, and a security system. In more detail, a plurality of video servers may be included in a first zone, a plurality of document servers may be included in a second zone, a plurality of servers related to a predetermined private enterprise may be included in a third zone, and a plurality of servers related to a predetermined public institution may be included in a fourth zone.

Each of the zone schedulers 220, 230, 240, and 250 may control traffic between servers included in respective zones. Here, the traffic between servers included in an identical zone is referred to as an intra-zone traffic, and the traffic between servers included in different servers is referred to as an inter-zone traffic.

Because the servers are classified based on a type, an amount of intra-zone traffic may be greater than an amount of inter-zone traffic. That is, a proportion of intra-zone traffic to whole traffic may be greater than a proportion of inter-zone traffic to whole traffic.

A size of zone may vary depending on a size of an aggregation switch or a structure of data center, and 24 through 96 racks may be provided. Similar to a rack scale technology, technologies for distributing a function to various racks instead of distributing the function to each server are available and thus, the amount of traffic within an identical zone gradually increases.

The present disclosure may use a technology using a scheduler separated for each zone other than using a centralized scheduler. The scheduler separated for each zone is referred to as a zone scheduler. The zone scheduler may perform scheduling on an input using a corresponding zone as an output. Thus, the zone scheduler may provide a grant for the zone by receiving a request from all input photonic wrapper IC assemblies (PWIAs).

The IZSC 210 may adjust scheduling of each of the zone schedulers 220, 230, 240, and 250. The description of the present disclosure is provided based on the four zone schedulers 220, 230, 240, and 250 with reference to FIG. 2, but a number of zone schedulers connected to the IZSC 210 is not limited thereto.

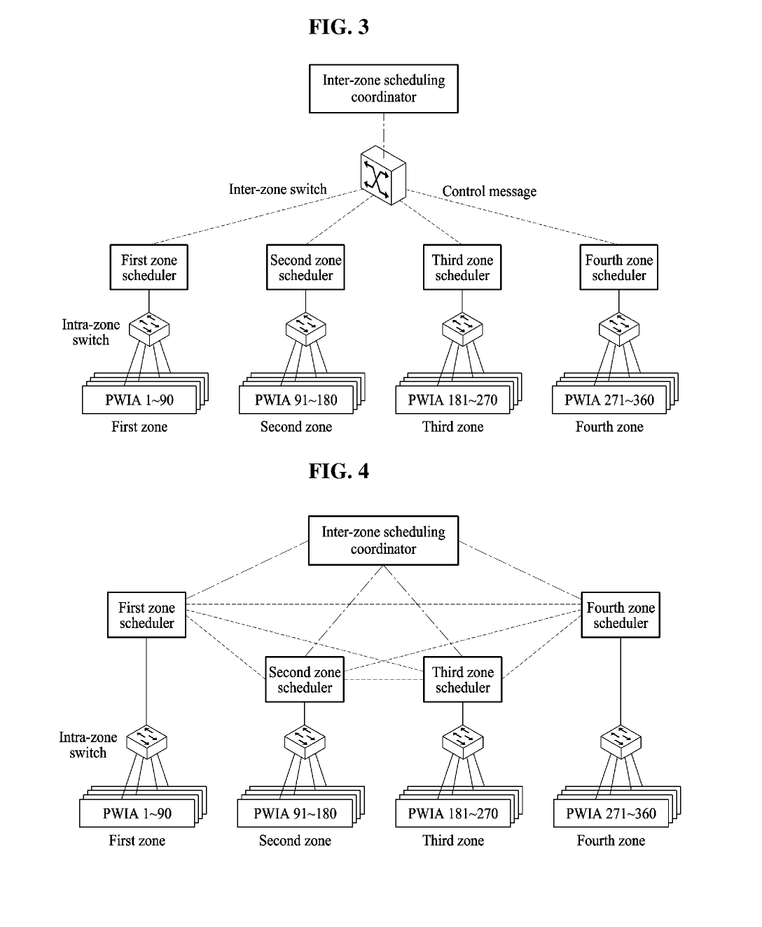

FIGS. 3 through 5 are diagrams each illustrating a connection relationship between an inter-zone scheduling coordinator (IZSC) and a plurality of zone schedulers according to an example embodiment.

FIGS. 3 through 5 illustrate examples of network connection relationships.

A zone scheduler may be connected to an input photonic wrapper IC assembly (PWIA) to transmit and receive a request and a grant. Each PWIA may transmit a scheduling request to each of classified zones. A request for using a corresponding zone as a destination may be granted by the zone scheduler. The request may be transmitted to a target zone scheduler. The request and the grant may be exchanged through a control message, and paths on which control messages are exchanged are represented in dotted lines in FIGS. 3 through 5. Also, connections between an IZSC and zone schedulers are represented in dash dot lines.

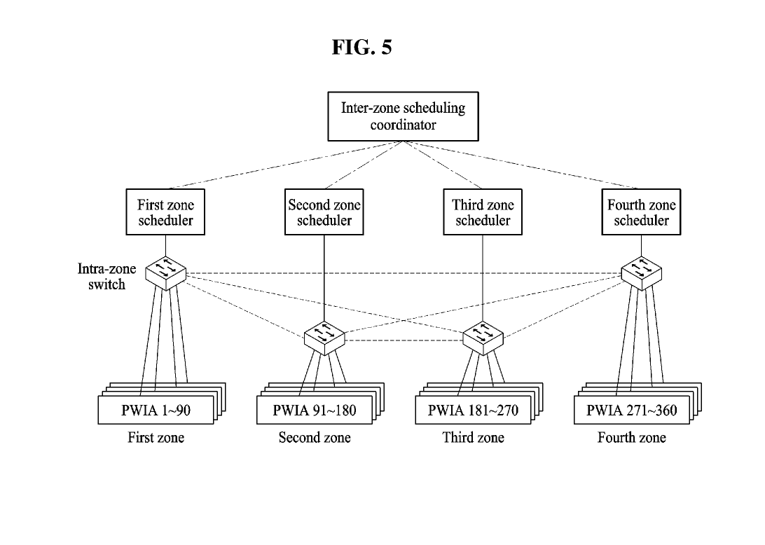

FIG. 3 illustrates a connection of a control plane. In more detail, FIG. 3 illustrates an example in which a plurality of zone schedulers is connected to the IZSC using an inter-zone switch to assemble control messages for respective zones. FIG. 4 illustrates an example in which a plurality of zone schedulers is directly connected to an IZSC. FIG. 5 illustrates an example of a connection of a control plane. In more detail, FIG. 5 illustrates an example in which a plurality of zone schedulers is connected to an IZSC using an intra-zone switch.

Referring to FIGS. 3 and 5, a control message may be encapsulated and transmitted to an Ethernet frame. Referring to FIG. 4, a control message may be transmitted to a separate control channel For example, in response to an occurrence of a packet to be transmitted to a fourth zone by a PWIA that belongs to a first zone, a request for the fourth zone may be transmitted from a PWIA 1 to a fourth zone scheduler via a first zone scheduler. A grant may be transmitted from the fourth zone scheduler to the PWIA 1 via the first zone scheduler.

Referring to FIGS. 3 through 5, the PWIA 1 through a PWIA 90 are classified as a first zone, a PWIA 91 through a PWIA 180 are classified as a second zone, a PWIA 181 through a PWIA 270 are classified as a third zone, and a PWIA 271 through a PWIA 360 are classified as a fourth zone.

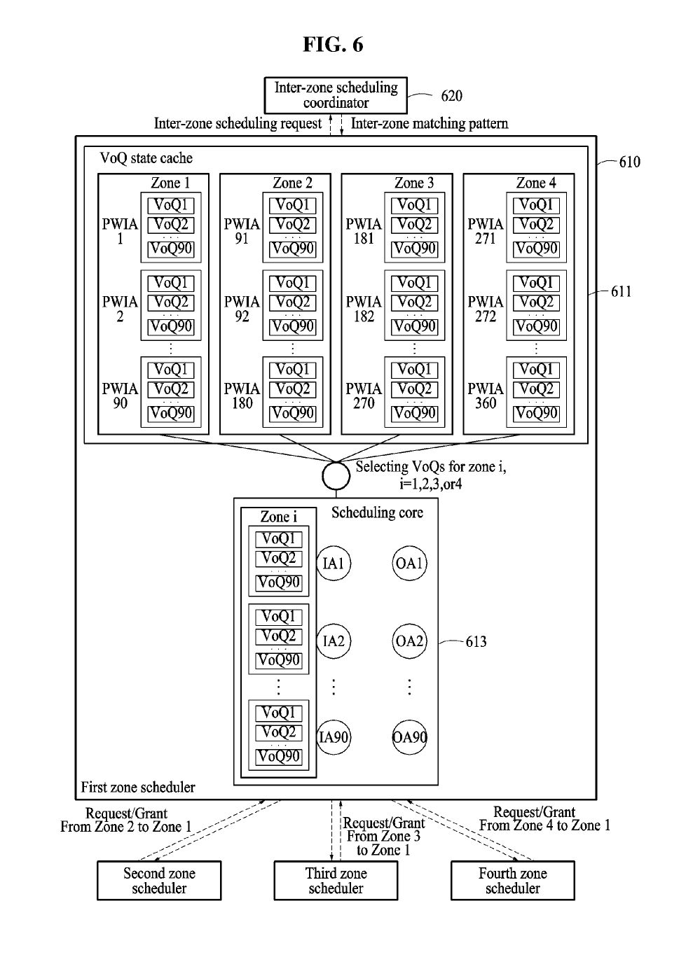

FIG. 6 is a diagram illustrating a zone scheduler according to an example embodiment. Referring to FIG. 6, a first zone scheduler 610 includes a virtual output queue (VoQ) state cache 611 and a scheduling core 613. Descriptions provided below may be also applicable to other zone schedulers, for example, a second zone scheduler, a third zone scheduler, and a fourth zone scheduler.

The first zone scheduler 610 may control scheduling of all inputs using a corresponding zone, for example, a first zone, as an output. The first zone scheduler 610 may provide a grant by receiving a request from an input photonic wrapper IC assembly (PWIA). For example, the first zone scheduler 610 controls scheduling of all inputs that output the first zone.

The first zone scheduler 610 includes an input arbiter (IA) and an output arbiter (OA). The IA includes an arbiter corresponding to all input ports, and the OA includes an arbiter corresponding to an output port of a corresponding zone. The IA and the OA include a round robin pointer and perform scheduling based on a distribution structure.

The first zone scheduler 610 may perform scheduling in a time slot (TS) unit, and perform scheduling based on a zone. Thus, traffic between a plurality of zone schedulers needs to be controlled by an inter-zone scheduling coordinator (IZSC) 620.

The first zone scheduler 610 includes the VoQ state cache 611 that stores VoQ states of all input PWIAs and the scheduling core 613. Hereinafter, description about an operation of each constituent element is provided based on an example in which each of four zones includes 90 PWIAs.

The VoQ state cache 611 may store VoQ states, for example, VoQ1 through VoQ90 of a first zone, of a corresponding zone by receiving them from all input PWIAs, for example, PWIA 1 through PWIA 360.

In response to an inter-zone traffic occurring, the first zone scheduler 610 may transmit an inter-zone scheduling request to the IZSC 620. The IZSC 620 may allocate a time slot for performing inter-zone scheduling by combining requests received from a plurality of zone schedulers.

The scheduling core 613 may perform scheduling by updating a state of zone to which a VoQ state is allocated to a VoQ state. An IA received by a PWIA of a corresponding time slot may manage VoQ information classified for each zone, and perform scheduling by selecting a zone for each time slot. As illustrated in FIG. 6, 360 ports may be classified by four zones to manage VoQ states when 90 ports are managed by one zone. Thus, in terms of IA1, scheduling may be performed based on a VoQ state with respect to a first PWIA, that is, PWIA 1, PWIA 91, PWIA 181, and PWIA 271, of each zone. An IA i may control scheduling of an i-th PWIA, a 90+i-th PWIA, a 180+i-th PWIA, and a 270+i-th PWIA based on an inter-zone matching pattern to be allocated. However, an OA i may only control scheduling of the i-th scheduling corresponding to a zone.

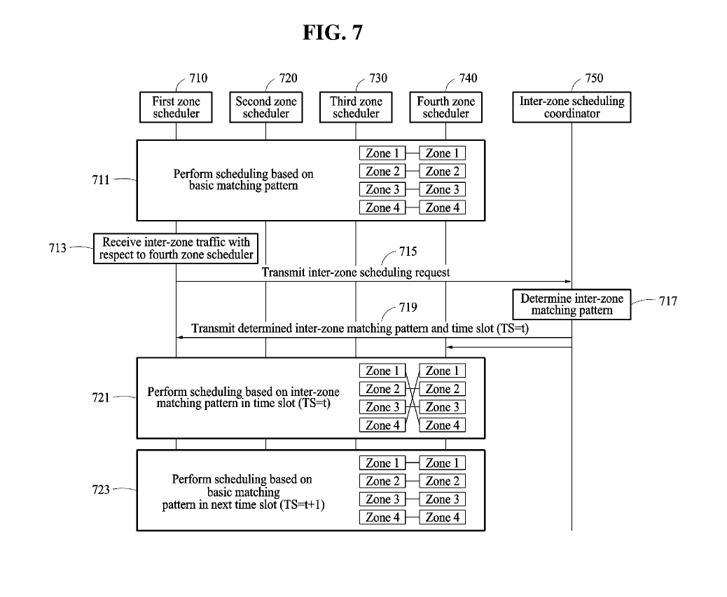

FIG. 7 is a diagram illustrating a communication method according to an example embodiment.

FIG. 7 illustrates the communication method performed by a plurality of zone schedulers 710 through 740 and an inter-zone scheduling coordinator (IZSC) 750.

An inter-zone matching pattern may be controlled by the IZSC 750 and transferred to the zone schedulers 710 through 740 to control scheduling.

In operation 711, the zone schedulers 710 through 740 perform scheduling based on a basic matching pattern. That is, each of the zone schedulers 710 through 740 may perform scheduling for an intra-zone traffic in an identical zone. For example, the first zone scheduler 710 may perform scheduling for an intra-zone traffic occurring in a first zone. Also, the second zone scheduler 720, the third zone scheduler 730, and the fourth zone scheduler 740 may perform scheduling for intra-zone traffics in respective zones.

When an inter-zone traffic with respect to another zone scheduler occurs, operation 713 may be performed. For ease of description, description about the first zone scheduler 710 receiving an inter-zone traffic with respect to the fourth zone scheduler 740 is provided below.

In operation 713, the first zone scheduler 710 receives the inter-zone traffic with respect to the fourth zone scheduler 740. For example, the inter-zone traffic occurs in a server belonging to a first zone and is transmitted to the first zone scheduler 710 through a photonic wrapper IC assembly (PWIA).

In operation 715, the first zone scheduler 710 transmits an inter-zone scheduling request to the IZSC 750. The inter-zone scheduling request may include information on a source zone that requests inter-zone scheduling, a destination zone to which the inter-zone scheduling is to be performed, and a number of non-empty virtual output queues (VoQs) for each destination zone.

In more detail, the inter-zone scheduling request is provided as shown in Table 1.

TABLE 1

| Parameter | Description |
|---|---|
| Source | Source zone that requires inter-zone packing switching, |
| Zone index | that is, source zone that requests inter-zone scheduling |
| List of | Zone list that requires inter-zone VoQ scheduling, that is, |
| Destination | destination zone to which inter-zone scheduling is to be |
| Zone index | performed |
| List of | Number of non-empty VoQs for each destination zone, |
| non-empty | that is, a number of VoQs of non-empty for each |
| VoQ count | destination zone |
| per Zone | |

For example, when a first zone corresponds to a source zone and a non-empty inter-zone VoQ corresponds to 91, 100, 200, 202, 230, and 320 (in FIG. 6), a source zone index may be 1, a list of destination zone index may be {2, 3, 4}, and a list of non-empty VoQ counter per zone may be {2, 3, 1}.

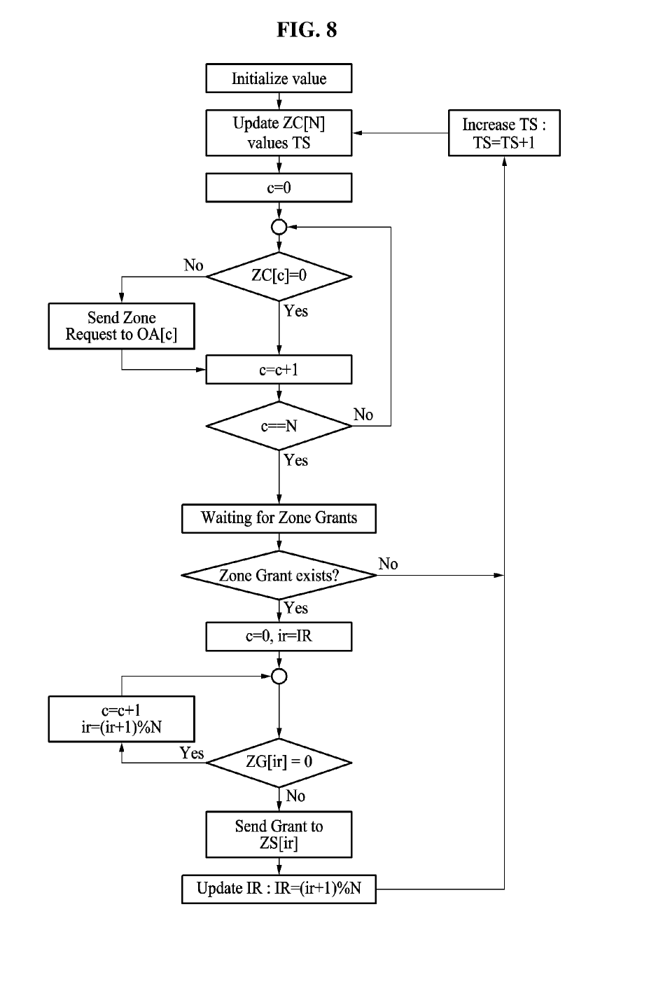

In operation 717, the IZSC 750 determines the inter-zone matching pattern. A method of determining the inter-zone matching pattern may include a single pair matching method of matching a pair of zones, and a full matching method of matching all zones. The single pair matching method may be more effective in response to a less amount of inter-zone traffic. The full matching method may be more effective in response to the greater amount of inter-zone traffic. Descriptions about the single pair matching method and the full matching method will be provided with reference to FIGS. 8 through 12.

The IZSC 750 may determine a time slot (Ts=t) for performing scheduling based on the determined inter-zone matching pattern.

In operation 719, the IZSC 750 transmits the determined inter-zone matching pattern and information on the time slot (TS=t) to the first zone scheduler 710 and the fourth zone scheduler 740. The IZSC 750 may transmit information on the source zone that requests inter-zone scheduling, the destination zone capable of performing scheduling with the source zone, and a time slot for performing the inter-zone scheduling. Such information may be associated with a zone matching pattern message, and the information is provided as shown in Table 2.

TABLE 2

| Parameter | Description |
|---|---|
| Source | Source zone that requires inter-zone packing switching, |
| Zone index | that is, source zone that requests inter-zone scheduling |
| Destination | Destination zone capable of performing switching in source |
| Zone index | zone, that is, destination zone capable of scheduling with |
| | source zone |
| Time Slot | Time slot number for performing inter-zone packing |
| | switching using source-destination pair, that is, time slot for |
| | performing inter-zone scheduling |

In operation 721, the first zone scheduler 710 and the fourth zone scheduler 740 perform scheduling based on the inter-zone matching pattern in the time slot (TS=t). That is, the first zone scheduler 710 and the fourth zone scheduler 740 may change a scheduling pattern based on the inter-zone matching pattern. For example, the first zone scheduler 710 may transmit the traffic to the fourth zone scheduler 740, and the fourth zone scheduler 740 may transmit the traffic to the first zone scheduler 710 based on the inter-zone matching pattern.

In operation 723, the first zone scheduler 710 and the fourth zone scheduler 740 perform scheduling based on the basic matching pattern in a next time slot (TS=t+1). That is, the first zone scheduler 710 and the fourth zone scheduler 740 may perform scheduling for the intra-zone traffic in the next time slot (TS=t+1).

FIGS. 8 through 10 are diagrams illustrating a complete matching algorithm according to an example embodiment.

A full matching method may provide a greatest number of matching combinations based on all zones. The full matching method may apply N! (N factorial) inter-zone matching patterns. The full matching method may determine respective destination zones for zone schedulers based on a number of VoQs accumulated in each of the zone schedulers. For example, the inter-zone matching pattern may be determined as first zone→second zone, second zone→third zone, third zone→fourth zone, and fourth zone→first zone when a greatest number of VoQs with respect to a second zone scheduler are accumulated in a first zone scheduler, a greatest number of VoQs with respect to a third zone scheduler are accumulated in a second zone scheduler, a greatest number of VoQs with respect to a fourth zone scheduler are accumulated in a third zone scheduler, and a greatest number of VoQs with respect to the first zone scheduler are accumulated in the fourth zone scheduler.

Because the full matching method determines a matching pattern based on a number of VoQs accumulated in each of the zone schedulers without a constraint condition for matching, a matching pattern may be selected based on a single pair matching method even when the full matching method is used in some cases.

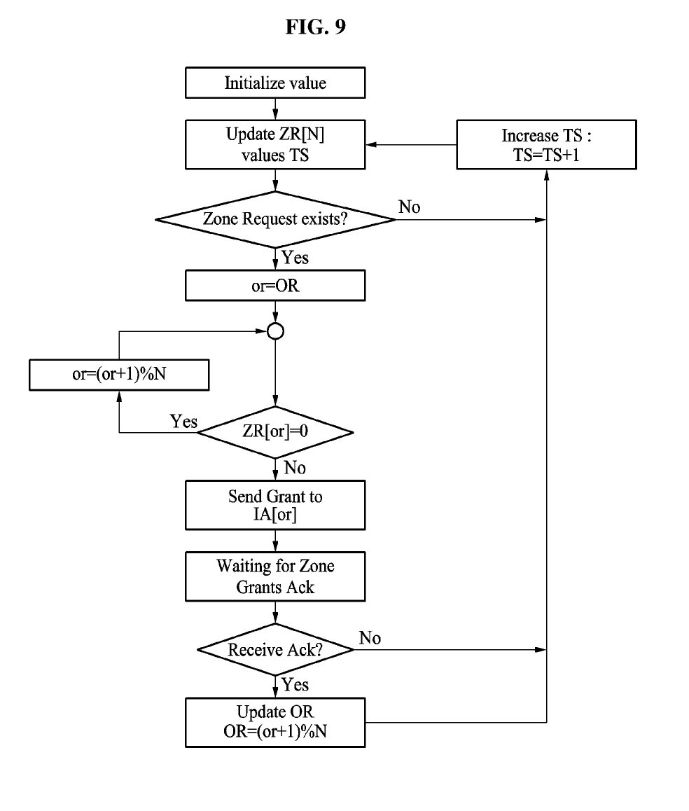

The full matching method may be performed as shown in flowcharts illustrated in FIGS. 8 and 9. FIG. 8 illustrates an operation of an input arbiter (IA), and FIG. 9 illustrates an operation of an output arbiter (OA). Thus, the full matching method may allow the IA and the OA to operate separately or consecutively. Because several iterations are requested to enhance throughput, a restraint element may be present when a length of time slot decreases due to a high-speed switch.

Referring to FIG. 8, N denotes a number of zones, TS denotes a time slot value, IR denotes an input round robin pointer, it denotes a temporary value of IR, ZC[N] denotes a number of non-empty VoQs for N zones as a zone counter, and ZG[N] denotes a zone grant from N OAs.

Referring to FIG. 9, N denotes a number of zones, TS denotes a time slot value, OR denotes an output round robin pointer, or denotes a temporary value of OR, ZR[N] detnoes a zone request from N input zones, and ZG[N] denotes a zone grant from N OAs.

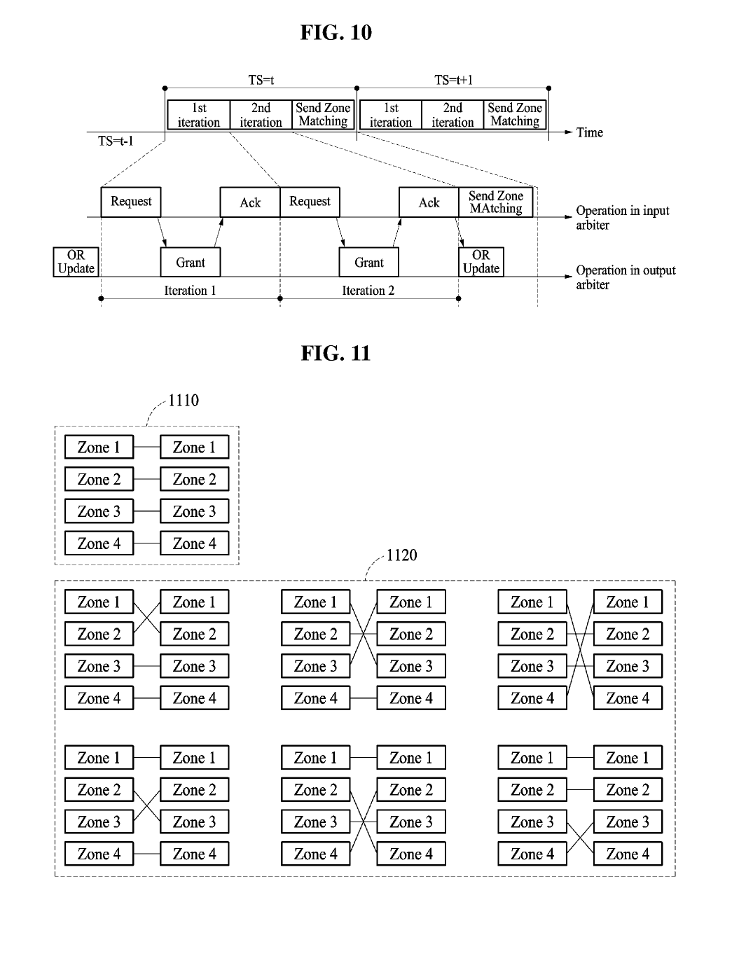

FIG. 10 illustrates operations of IAs and OAs based on the full matching method as time elapses. One time slot may include first iteration, second iteration, and zone matching transmission. A request, a grant, and an Ack may occur in each iteration.

FIG. 11 is a diagram illustrating an inter-zone matching pattern based on a single-pair matching algorithm according to an example embodiment.

A single pair matching method may match a pair of zone schedulers that require scheduling most among a plurality of zone schedulers. Based on a feature of data center that most traffic occurs inside a zone, only the pair of zone schedulers that require the scheduling most may be selected from among the zone schedulers to perform inter-zone scheduling. When a number of zones corresponds to N, a matching pattern based on the single pair matching method may include one basic matching pattern 1110 and an inter-zone matching pattern 1120 including N*(N−1)/2 zones.

FIG. 11 illustrates that there are four zones. The single pair matching method may perform the scheduling based on any one pattern selected from among matching patterns illustrated in FIG. 11.

The single pair matching method may match two zone schedulers between which a greatest amount of inter-zone traffic occurs among the zone schedulers.

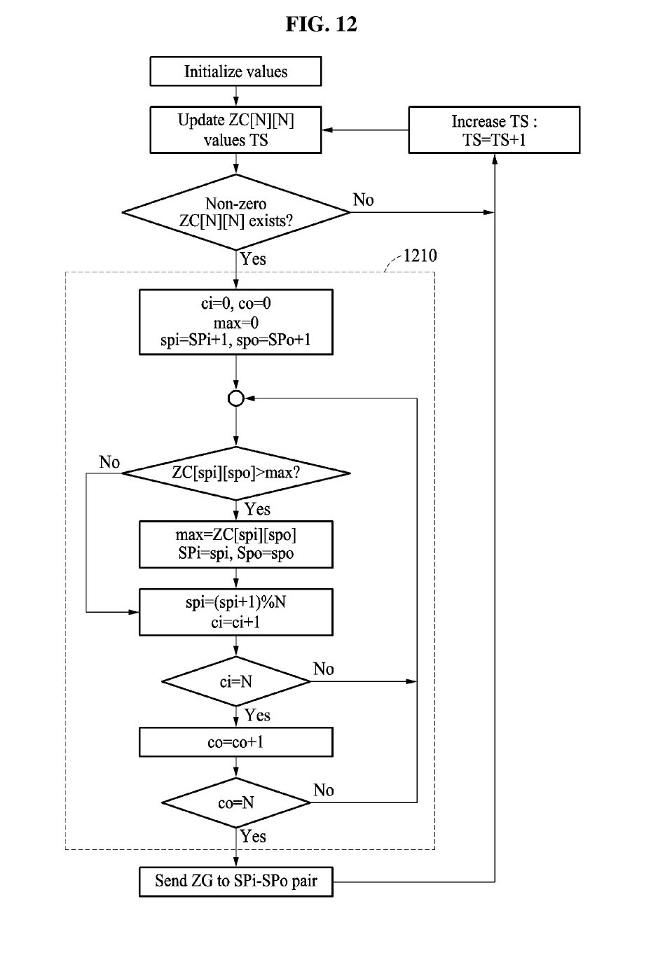

FIG. 12 is a diagram illustrating a single-pair matching algorithm according to an example embodiment.

A single pair matching method may be appropriate when there is a greatest amount of intra-zone traffic. A pattern that requires scheduling most may be selected from among N*(N−1)/2 inter-zone matching patterns to perform scheduling for the intra-zone traffic. The single pair matching method may be implemented even when a length of time slot decreases because sequential operations required for separately using an input arbiter (IA) and an output arbiter (OA) are unnecessary. That is, unlike a full matching method, the single pair matching method may not require sequential controls, operation 1210 may be performed based on a sorting logic through hardware (HW).

Referring to FIG. 12, N denotes a number of zones, Ts denotes a time slot value, SPi denotes a selection pointer for input zone, SPo denotes a selection pointer for output zone, ZC[N][N] denotes zone counters from N inputs to N outputs, and ZG[N] denotes a zone grant from N OAs.

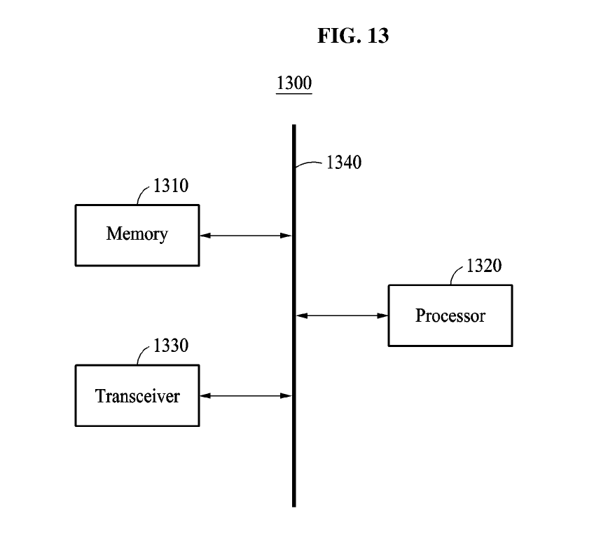

FIG. 13 is a block diagram illustrating an electronic device according to an example embodiment.

Referring to FIG. 13, an electronic device 1300 includes a memory 1310, a processor 1320, and a transceiver 1330. The memory 1310, the processor 1320, and the transceiver 1330 may communicate with each other via a bus 1340. The above-described communication device 1300 and a user terminal may be implemented as at least a portion of an electronic system.

The memory 1310 includes instructions to be readable by a computer. The processor 1320 performs the above-described operations in response to the instructions stored in the memory 1310 being executed by the processor 1320. The memory 1310 may be a volatile memory or a non-volatile memory.

The processor 1320 is an apparatus for executing instructions or programs, and controlling the electronic device 1300. For example, the processor 1320 includes a central processing unit (CPU) and a graphic processing unit (GPU).

The processor 1320 may include at least one of apparatuses described above with reference to FIGS. 1 through 12, or perform at least one of methods described above with reference to FIGS. 11 through 12. For example, the processor 1320 included in a zone scheduler transmits an inter-zone scheduling request to an inter-zone scheduling coordinator (IZSC) in response to an occurrence of an inter-zone traffic with respect to other zone schedulers, receives an inter-zone matching pattern and information on a time slot from the IZSC, and performs scheduling based on the inter-zone matching pattern in a time slot.

In addition, the processor 1320 included in the IZSC may receive an inter-zone scheduling request with respect to a second zone scheduler from a first zone scheduler in which an inter-zone traffic occurs, determine an inter-zone matching pattern and information on a time slot for performing scheduling based on the inter-zone matching pattern based on the inter-zone scheduling request, and transmit the inter-zone matching pattern and the information on the time slot to the first zone scheduler and the second zone scheduler.

The transceiver 1330 may transmit data processed by the processor 1320 to another apparatus. The transceiver 1330 may receive the data from the other apparatus and transmit the data to the processor 1320.

Repeated descriptions will be omitted for increased clarity and conciseness because the descriptions provided with reference to FIGS. 1 through 12 are also applicable to the respective constituent element of FIG. 13.

According to example embodiments described herein, it is possible to provide a mono-hierarchical network to minimize a delay between terminations and prevent a quality degradation occurring in a hierarchical network.

According to example embodiments described herein, it is possible to control starvation and prevent a duplicated grant problem that grants simultaneously occur from one input to a plurality of output ports by controlling a scheduling operation of a plurality of zone schedulers based on an inter-zone matching pattern determined by an inter-zone scheduling coordinator (IZSC). In addition, it is possible to effectively solve a scalability problem occurring in response to an input arbiter (AI) corresponding to all inputs while an output arbiter (OA) corresponds to each zone.

According to example embodiments described herein, it is possible to guarantee a high performance with respect to a traffic occurring between identical zones in addition to a high performance of a traffic occurring between different zones when the present disclosure is applied to a network of a zone-based data center.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method comprising:
transmitting an inter-zone scheduling request to an inter-zone scheduling coordinator (IZSC) in response to an occurrence of an inter-zone traffic with respect to another zone scheduler;
receiving an inter-zone matching pattern and information on a time slot from the IZSC; and
transmitting the inter-zone traffic to a scheduler corresponding the other zone by performing scheduling based on the inter-zone matching pattern in the time slot.

2. The method of claim 1, further comprising:
performing scheduling for an intra-zone traffic in a time slot differing from the time slot,
wherein the intra-zone traffic occurs between a plurality of servers included in a zone corresponding to a zone scheduler performing the communication method.

3. The method of claim 1, wherein the inter-zone scheduling request includes information on a source zone that requests inter-zone scheduling, a destination zone to which the inter-zone scheduling is to be performed, and a number of non-empty virtual output queues (VoQs) for each destination zone.

4. The method of claim 1, wherein the receiving of the inter-zone matching pattern and the information on the time slot comprises receiving information on a source zone that requests inter-zone scheduling, a destination zone capable of performing scheduling with the source zone, and a time slot for performing the inter-zone scheduling.

5. The method of claim 1, wherein the inter-zone matching pattern matches at least two zone schedulers that require the scheduling most among a plurality of zone schedulers of which the scheduling is controlled by the IZSC.

6. The method of claim 5, wherein the inter-zone matching pattern controls the scheduling of the zone schedulers based on an inter-zone traffic of the zone schedulers.

7. The method of claim 1, wherein a zone scheduler performing the communication method controls an intra-zone traffic between a plurality servers classified as an identical zone based on a type.

8. A communication method performed by an inter-zone scheduling coordinator (IZSC), the method comprising:
receiving an inter-zone scheduling request with respect to a second zone scheduler from a first zone scheduler in which an inter-zone traffic occurs;
determining an inter-zone matching pattern based on the inter-zone scheduling request and information on a time slot in which scheduling is to be performed based on the inter-zone matching pattern; and
transmitting the inter-zone matching pattern and the information on the time slot to the first zone scheduler and the second zone scheduler.

9. The method of claim 8, wherein the determining of the inter-zone matching pattern and the information on the time slot comprises determining information on a source zone that requests inter-zone scheduling, a destination zone capable of performing scheduling with the source zone, and a time slot in which the inter-zone scheduling is to be performed.

10. The method of claim 8, wherein the inter-zone matching pattern matches a first zone scheduler and the second zone scheduler that require the scheduling most among a plurality of zone schedulers of which the scheduling is controlled by the IZSC.

11. The method of claim 10, wherein a greatest amount of inter-zone traffic occurs between the first zone scheduler and the second zone scheduler, among the zone schedulers.

12. The method of claim 8, wherein the inter-zone matching pattern controls scheduling of at least three zone schedulers based on the inter-zone traffic of a plurality of zone schedulers of which the scheduling is controlled by the IZSC, and is determined to perform the scheduling for the inter-zone traffic from the first zone scheduler to the second zone scheduler.

13. The method of claim 8, wherein each of the first zone scheduler and the second zone scheduler performs scheduling based on the inter-zone matching pattern in the time slot and performs scheduling for an intra-zone traffic between a plurality of servers classified as an identical zone based on a type in a time slot differing from the time slot.

14. The method of claim 8, wherein the inter-zone scheduling request includes information on a source zone that requests inter-zone scheduling, a destination zone to which the inter-zone scheduling is to be performed, and a number of non-empty virtual output queues (VoQs) for each destination zone.

15. The method of claim 8, wherein the determining of the inter-zone matching pattern and the information on the time slot comprises determining the inter-zone matching pattern for matching at least two zone schedulers among a plurality of zone schedulers such that a greatest amount of inter-zone traffic occurring from the zone schedulers connected to the IZSC is processed, and an input arbiter (IA) and an output arbiter (OA) of each of the zone schedulers independently and sequentially operate.

16. The method of claim 8, wherein the determining of the inter-zone matching pattern and the information on the time slot comprises selecting, as the inter-zone matching pattern, a basic matching pattern for matching two schedulers that require the scheduling most from among basic matching patterns for matching two zone schedulers among a plurality of zone schedulers connected to the IZSC.

17. A zone scheduler comprising:
a processor; and
a memory comprising at least one instruction to be executable by the processor,
wherein, in response to the at least one instruction being executed by the processor, the processor is configured to transmit an inter-zone scheduling request to an inter-zone scheduling coordinator (IZSC) in response to an occurrence of an inter-zone traffic with respect to another zone scheduler, receive an inter-zone matching pattern and information on a time slot from the IZSC, and transmit the inter-zone traffic to the other zone scheduler by performing scheduling based on the inter-zone matching pattern in the time slot.

18. The zone scheduler of claim 17, further comprising:
a scheduling core configured to perform scheduling using a zone corresponding to the zone scheduler as an output port; and
a virtual output queue (VoQ) state cache configured to store a VoQ state using the zone corresponding to the zone scheduler as the output port in input ports of all zones connected to the IZSC.

19. The zone scheduler of claim 18, wherein the scheduling core performs the scheduling based on the inter-zone matching pattern by changing a state of a predetermined source zone to a VoQ state based on the inter-zone matching pattern.

20. The zone scheduler of claim 17, wherein the processor is configured to perform scheduling for an intra-zone traffic in a time slot differing from the time slot, and the intra-zone traffic occurs between a plurality of servers included in a zone corresponding to the zone scheduler.
